(19) United States
(12) Patent Application Publication
(10) Pub. No.: US 2007/0000295 A1
(43) Pub. Date: Jan. 4, 2007

(54) Electronic key

(75) Inventors: Harald Donner, Meinerzhagen (DE); Jorg Welschholz, Herscheid (DE)

Correspondence Address: BROOKS KUSHMAN P.C., 1000 TOWN CENTER, TWENTY-SECOND FLOOR, SOUTHFIELD, MI, 48075, US

(73) Assignee: Leopold Kostal GmbH & Co., Ludenscheid (DE)

(21) Appl. No.: 11/021,321

(22) Filed: Dec. 23, 2004

Related U.S. Application Data
(63) Continuation of application No. PCT/EP03/06605, filed on Jun. 24, 2003.

(30) Foreign Application Priority Data
Jun. 26, 2002 (DE) 102 28 616.7

(51) Int. Cl. E05B 43/00; E05B 37/00

(52) U.S. Cl. 70/271; 70/285

(57) ABSTRACT

An electronic key for operating a lock includes a housing having an electronic circuit for remotely operating the lock. A holding fixture is in the housing for receiving a key bit longitudinally displaced into the housing in order to removably hold the key bit within the housing. The holding fixture removably holds the key bit within the housing to enable the key bit to be longitudinally displaced out from the housing to enable the key bit to mechanically operate the lock. A retaining element includes an eyelet for attaching or hanging the electronic key. The retaining element is movably arranged in the housing such that the retaining element and the eyelet are concealed within the housing when the holding fixture is holding a key bit and such that the eyelet protrudes from the housing when the holding fixture is void of a key bit.

The present invention concerns an electronic key for operating a lock, particularly for use in locking systems for motor vehicles with a housing which encompasses the electronic circuit which serves to operate the lock and which has moreover a holding fixture for a key bit which is held therein, can be withdrawn in a longitudinally displaceable manner and is intended for a mechanical lock.

Electronic keys of the stated type are used in remote radio operation for central locking of motor vehicles, with radio communication which checks the authorization of the key being triggered between the key and a controller present in the motor vehicle either through intentional operation of controls in the key or by simply bringing the key close to the vehicle. In case of positive access authorization, automatic unlocking of the door locks occurs.

To enable opening of the vehicle even when the electronic key fails, at least one vehicle door is provided additionally with the capability of opening the corresponding lock with a mechanical key with a key bit. The required key bit which serves as an emergency key is usually accommodated directly in the housing of the electronic key in a corresponding holding fixture.

DE 195 05 190 A1 discloses in one embodiment a key according to the generic concept of the present main claim. The key bit for a mechanical lock which key bit is provided there as an emergency key and held in a holding fixture of the housing so as to be capable of being withdrawn in a longitudinally displaceable manner is provided on its end which protrudes out of the housing with an eyelet for attaching a key ring or for attaching or hanging the entire key.

The separation of the emergency key from the housing of the electronic key has since proven to be very convenient for the case in which the (electronic) vehicle key is provided to third parties, say, in a workshop or when parking, the remaining bunch of keys connected with a key ring with the emergency key being intended to remain, however, with the vehicle owner. However, a possibility of attaching or hanging the electronic key no longer exists in this case with the known key.

Compared to the prior art described here, the electronic key according to the present invention has the advantage that it has means for attaching or hanging the key even if the emergency key was removed without these means having a disruptive effect if the emergency key is contained in the housing.

This is enabled by the fact that in the housing a retaining element which is provided with an eyelet for attaching or hanging the key is arranged movably which is concealed completely in the housing when the key bit is inserted and when the key bit is withdrawn the eyelet protrudes at least partially extendably from the housing.

Advantageous refinements of the matter according to the invention are specified in the dependent claims and are explained in greater detail based on the embodiments shown in the drawing.

The figures are as follows:

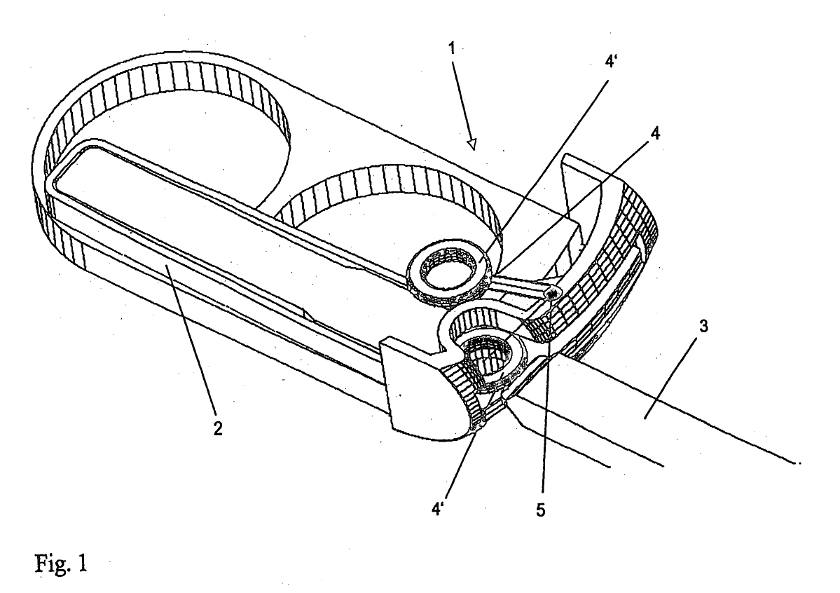

FIG. 1: An electronic key according to the invention with a swivelable retaining element

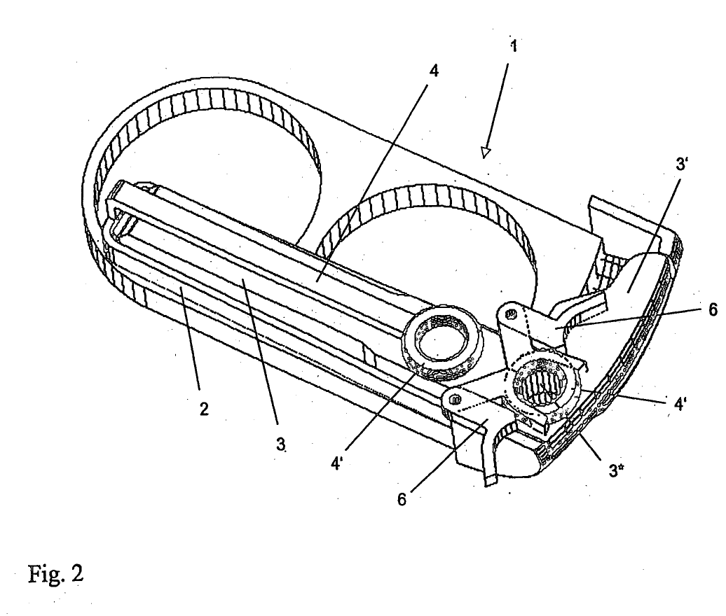

FIG. 2: An electronic key according to the invention with a retaining element which is longitudinally displaceable

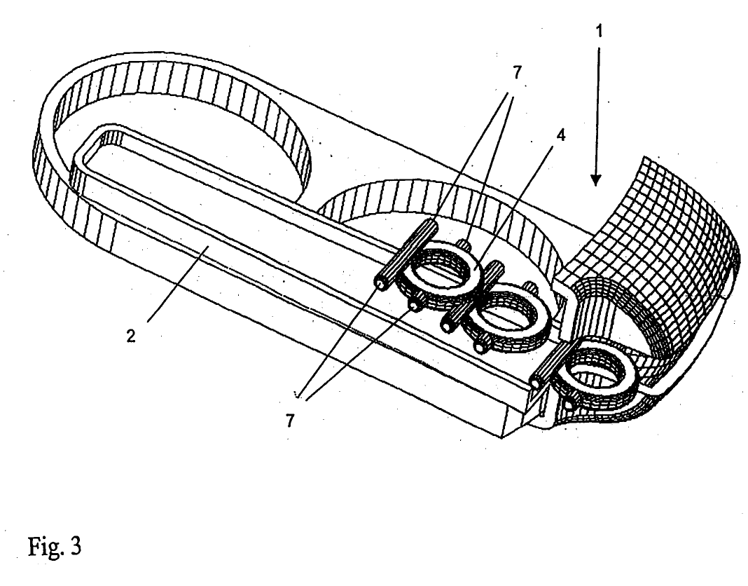

FIG. 3: An electronic key according to the invention with a retaining element which is movable along a sliding track

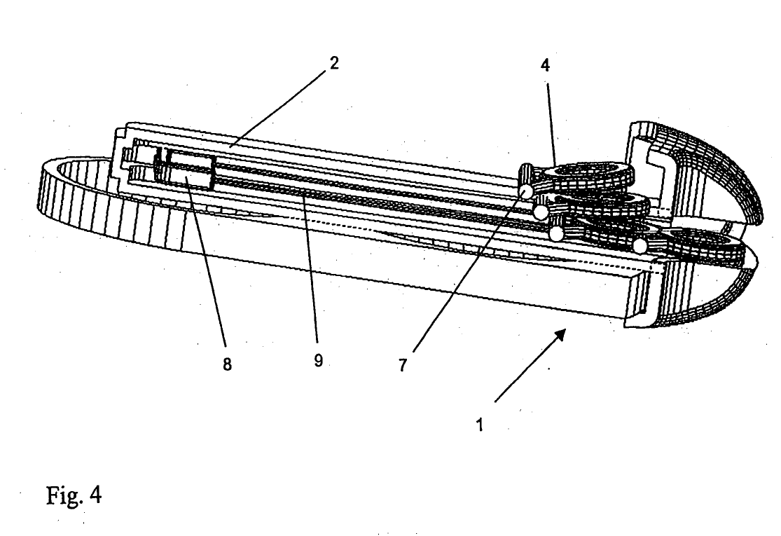

FIG. 4: A second embodiment of an electronic key with a retaining element which is movable along a sliding track

The electronic key according to the invention includes a housing 1 which is manufactured as a plastic injection-molded unit and contains inside of it a printed circuit board which supports the electronic circuit which serves to operate the lock present in the motor vehicle. For greater clarity, only the parts of the key that are significant to the invention are shown in the drawing, and they are shown schematically to a certain extent. Housing 1 is shown in a open view, and the printed circuit board which is not relevant in connection with the present invention is omitted. This circuit on this printed circuit board which is not shown includes, i. a., means for performing an access authorization check, such as a microprocessor as well as transmitting and possibly receiving means which are suitable for the radio frequency range which is used. To provide the required electrical power, batteries are also contained in housing 1 which are held in the round break-outs present in the housing interior. Laterally in housing 1, a holding fixture 2 created in the form of a longitudinal pocket is present for an emergency key. The emergency key consists essentially of a key bit 3 for a mechanical lock which is provided on its one end with a grip end 3′ which enables its handling. The emergency key is arranged in the holding fixture 2 of housing 1 so that only a section of its grip end 3′ (which section has an eyelet 3* provided to attach a key ring) protrudes out of housing 1. In the position in which it is inserted into housing 1, the emergency key is stopped by a bolt which can be displaced perpendicularly to the displacement direction of key bit 3 in housing 1 (the operating element of the bolt is located on the back side of the housing and is not seen in the drawing). In order to withdraw the emergency key from housing 1, the bolt is put into its unlocking position, and the emergency key is withdrawn towards the back from housing 1. Also arranged in housing 1 is a retaining element 4 which is provided with an eyelet 4′ and intended to attach or hang the key. This retaining element 4 is supported movably in the housing, and is completely concealed in housing 1 when key bit 3 of the emergency key is inserted, it being held in an upright manner under spring prestress against key bit 3. When the emergency key is pulled out, a movement of retaining element 4 is enabled by means of which it reaches a position when key bit 3 is fully withdrawn which releases eyelet 4′ at least partially and protrudes from housing 1. In the drawing, a plurality of positions of retaining element 4 is shown simultaneously to some extent in order to be able to clarify the movement.

In the embodiment in FIG. 1, retaining element 4 is formed as a swivel arm which is arranged in a rotatably supported manner about an axis 5. Two positions of retaining element 4 are shown, such that in the position in which eyelet 4′ is located partially outside of the housing that retaining element 4 is arranged with the eyelet 4′ applied on its far axial end at the height of the center of key bit 3 so that direct contact exists between an edge of key bit 3 and the retaining element 4. The other shown position of eyelet 4′ corresponds to its position with key bit 3 inserted. The swivel arm is under spring prestress in this position in order to enable an automatic swinging out of eyelet 4′ when pulling out key bit 3. Compared to the next embodiment which is shown, this embodiment has the disadvantage that a relatively large construction space is required for the entire arrangement since the swivel arm of retaining element 4 must cover an angle of almost 90° during its movement. However, the benefit of this arrangement is related to its simple mechanical design. As a result of the inserted emergency key, the opening present in housing 1 is completely sealed without additional parts being necessary for this purpose (as is the case, for example, in the embodiment in FIG. 3). There, sealing elements 6 are provided in order to prevent, say, the penetration of dirt into the interior of the key.

FIGS. 2, 3 and 4 show embodiments in which retaining element 4 is arranged so it can be displaced instead of swiveled.

In FIG. 2, retaining element 4 is formed as a drawbar guided in holding fixture 2 for key bit 3. This drawbar is angled on its end which faces away from eyelet 4′ in order to form a stop for key bit 3, and is arranged against a spring prestress in a longitudinally displaceable manner in holding fixture 2. The spring prestress is applied, say, by means of a screw or leg spring (not shown here) acting upon the angled end of retaining element 4. When key bit 3 is not inserted, eyelet 4′ of retaining element 4 protrudes out of housing 1. When the emergency key is inserted, key bit 3 is first introduced up to its stop at the angled end of the drawbar, and then it takes along the entire retaining element 4 with it over the last section of 30 its movement, eyelet 4′ disappearing simultaneously in housing 1. When eyelet 4′ disappears in the housing, it enables a swiveling movement of sealing elements 6 which when eyelet 4′ is protruding are held under spring prestress against it in an upright manner, and which seal the opening present above the emergency key when eyelet 4′ has disappeared in the housing.

In the embodiment shown in FIG. 3, retaining element 4 is formed as an essentially ring-shaped member which is guided by means of laterally arranged pegs 7 in a sliding track (not shown) which is molded in housing 1. This sliding track guides retaining element 4 in a movement track which contains a component lying in a direction perpendicular to the direction of movement of key bit 3. When key bit 3 is introduced, retaining element 4 can thus divert into a position which lies parallel to key bit 3. The resetting of retaining element 4 takes place here too by means of a spring which acts contrary to the diverting movement of retaining element 4. The movement track of retaining element 4 should be expediently adapted in terms of its course to the available construction space as well as the friction conditions which exist between key bit 3 and retaining element 4. In case of sufficient construction space, a movement of retaining element 4 on a circuit which is directed upwards has proven to be advantageous.

The further embodiment shown in FIG. 4 represents basically a combination of the embodiments in FIGS. 2 and 3. Here too, retaining element 4 is formed as an essentially ring-shaped member which is guided by means of laterally protruding pegs in a sliding track molded in housing 1. When key bit 3 is inserted, retaining element 4 is initially driven directly by it until retaining element 4 has diverted so far upwards that key bit 3 can slide through under retaining element 4. Similar to FIG. 2, the tip of key bit 3 acts against the end of the insertion path on the stop of a pulling element 8, and moves it against a spring until the final inserted position of the emergency key in housing 1 towards the back is reached. Here, retaining element 4 which is connected with pulling element 8 by means of spring wires 9 is moved on its sliding track further until its final position is reached. The rigid-elastic connection of retaining element 4 with pulling element 8 (which can be realized, say, also using elastic strips, plastic bars or similar coupling elements) makes it possible to arrange pegs 7 for guiding retaining element 4 so they lie significantly behind it, and thus to implement the sliding track for guiding them at a shorter distance to the housing opening. This allows greater freedom in designing the emergency key, particularly the grip end 3′, which in the embodiment in FIG. 3 can possibly collide with the housing wall needed to hold the sliding track. In this embodiment too, the opening 1′ present in housing 1 is completely sealed by the inserted emergency key.

1-10. (canceled)

11. An electronic key for operating a lock, the electronic key comprising:
a housing having an electronic circuit for remotely operating the lock;
a holding fixture in the housing for receiving a key bit longitudinally displaced into the housing in order to removably hold the key bit within the housing, the holding fixture removably holding the key bit within the housing to enable the key bit to be longitudinally displaced out from the housing to enable the key bit to mechanically operate the lock; and
a retaining element having an eyelet for attaching or hanging the electronic key, the retaining element being movably arranged in the housing such that the retaining element and the eyelet are concealed within the housing when the holding fixture is holding a key bit and such that the eyelet protrudes from the housing when the holding fixture is void of a key bit.

12. The electronic key of claim 11 wherein:
the retaining element includes a swivel arm which is rotatably supported at a first end about an axis and is attached at a second end to the eyelet, the swivel arm being prestressed to rotate about the axis to move the eyelet such that the eyelet protrudes from the housing when the holding fixture is void of a key bit.

13. The electronic key of claim 11 wherein:
the retaining element includes a draw bar guided in the holding fixture, the draw bar being longitudinally prestressed in the housing such that a key bit inserted into the holding fixture moves the retaining element and the eyelet such that the eyelet becomes concealed within the housing as the key bit is inserted into the holding fixture.

14. The electronic key of claim 13 further comprising:
a plurality of sealing elements associated with the eyelet for sealing the housing, wherein the sealing elements are prestressed when the eyelet protrudes from the housing such that the sealing elements seal the housing when the eyelet is concealed within the housing.

15. The electronic key of claim 11 wherein:
the retaining element includes a ring-shaped member which is guided by laterally protruding pegs in a sliding track in the housing, the sliding track containing a component lying in a direction perpendicular to longitudinally displaced movement of a key bit within the holding fixture such that when a key bit is inserted into the holding fixture the retaining element diverts into a position which lies parallel to the key bit by acting against an elastic force.

16. The electronic key of claim 15 wherein:
the retaining element is connected with a pulling element guided in the holding fixture by a plurality of rigid-elastic coupling elements.

17. The electronic key of claim 11 wherein:
the key bit includes a grip end which enables handling of the key bit into and out of the holding fixture.

18. The electronic key of claim 11 wherein:
a section of a key bit having an eyelet protrudes out of the housing when the key bit is removably held within the holding fixture, the eyelet of the key bit being used for attaching a key ring.

19. The electronic key of claim 11 wherein:
in the position inserted in the housing, the key bit can be stopped by a bolt which is perpendicularly adjustable to longitudinal displacement of the key bit within the holding fixture.

20. The electronic key of claim 11 wherein:
the key bit is an emergency key provided for the case in which the electronic key fails to operate the lock.

21. An electronic key for operating a lock, the electronic key comprising:
a housing having an electronic circuit for remotely operating the lock;
a holding fixture in the housing for removably holding a key bit intended for mechanically operating the lock; and
a retaining element having an eyelet, the retaining element being movably arranged within the housing such that the retaining element and the eyelet are concealed within the housing when the holding fixture is holding a key bit and such that the eyelet protrudes from the housing when the holding fixture is void of a key bit, wherein the eyelet is attachable to an object to hang the housing from the object when the eyelet protrudes from the housing.

22. The electronic key of claim 21 wherein:
the retaining element includes a swivel arm which is rotatably supported at a first end about an axis and is attached at a second end to the eyelet, the swivel arm being prestressed to rotate about the axis to move the eyelet such that the eyelet protrudes from the housing when the holding fixture is void of a key bit.

23. The electronic key of claim 21 wherein:
the retaining element includes a draw bar guided in the holding fixture, the draw bar being longitudinally prestressed in the housing such that a key bit inserted into the holding fixture moves the retaining element and the eyelet such that the eyelet becomes concealed within the housing as the key bit is inserted into the holding fixture.

24. The electronic key of claim 23 further comprising:
a plurality of sealing elements associated with the eyelet for sealing the housing, wherein the sealing elements are prestressed when the eyelet protrudes from the housing such that the sealing elements seal the housing when the eyelet is concealed within the housing.

25. The electronic key of claim 21 wherein:
the retaining element includes a ring-shaped member which is guided by laterally protruding pegs in a sliding track in the housing, the sliding track containing a component lying in a direction perpendicular to longitudinally displaced movement of a key bit within the holding fixture such that when a key bit is inserted into the holding fixture the retaining element diverts into a position which lies parallel to the key bit by acting against an elastic force.

26. The electronic key of claim 25 wherein:
the retaining element is connected with a pulling element guided in the holding fixture by a plurality of rigid-elastic coupling elements.

27. The electronic key of claim 21 wherein:
the key bit includes a grip end which enables handling of the key bit into and out of the holding fixture.

28. The electronic key of claim 21 wherein:
a section of a key bit having an eyelet protrudes out of the housing when the key bit is removably held within the holding fixture, the eyelet of the key bit being used for attaching a key ring.

29. The electronic key of claim 21 wherein:
in the position inserted in the housing, the key bit can be stopped by a bolt which is perpendicularly adjustable to longitudinal displacement of the key bit within the holding fixture.

30. The electronic key of claim 21 wherein:
the key bit is an emergency key provided for the case in which the electronic key fails to operate the lock.
